(19) United States
(12) Patent Application Publication
(10) Pub. No.: US 2002/0018595 A1
(43) Pub. Date: Feb. 14, 2002

(54) Method for creating caricature

(76) Inventor: Eun-Jun Kwak, Seoul (KR)

Correspondence Address: M. Arthur Auslander, Auslander & Thomas, 505 Eighth Avenue, New York, NY, 10018-6505, US

(21) Appl. No.: 09/897,742

(22) Filed: Jul. 2, 2001

(30) Foreign Application Priority Data
Jul. 5, 2000 (KR) 2000-38219

(51) Int. Cl. G06K 9/46

(52) U.S. Cl. 382/203

(57) ABSTRACT

Disclosed herein is a method for creating a caricature. Source data for the caricature creation is inputted, respective parts of the inputted source data are analyzed and a caricature model is extracted from an associated database on the basis of each of the analyzed results of the parts. Then, the analyzed and extracted results are synthesized and a background image is in turn synthesized with the synthesized result. Therefore, a minimal amount of time is required from the source data input to the caricature completion. Further, with no aid of any specialist, the user can create a caricature of a desired shape as well as being able to easily access the caricature.

### BACKGROUND OF THE INVENTION

1. Field of the Invention

The present invention relates in general to a method for creating a caricature, and more particularly to an automatic caricature creation method for facilitating the use and creation of a caricature by a general person.

2. Description of the Prior Art

Recently, with the advent of the Internet and the diversification of daily life affairs, caricatures have often been used to satirize known persons through the mass media.

Caricatures have gradually become so diverse that they are made to satirize persons ranging from the President to a star performer.

Such a caricature is made by modifying partial elements of a person by degrees while sustaining the entire image of the person. It may satirize or degrade the person according to the modification degrees or methods. Caricatures have recently been used for various purposes. For example, a certain Internet company provides a card mail service employing a caricature of a specific person as a background image.

Most caricatures are currently created with the aid of specialists in the field in such a manner that respective partial elements of persons are directly enlarged or otherwise modified. In this regard, a large amount of time is required in creating one caricature. Further, each caricature is created according to an artist's intention rather than according to a general person's intention, thereby causing the general person to have a very narrow choice of caricature selection.

### SUMMARY OF THE INVENTION

Therefore, the present invention has been made in view of the above problems, and it is an object of the present invention to provide a caricature creation method for making it easy for a general person to access a caricature and create it.

In accordance with the present invention, the above and other objects can be accomplished by the provision of a method for creating a caricature, comprising the steps of inputting a source photograph for the caricature creation; analyzing respective parts of the inputted source photograph and extracting caricature models from associated databases on the basis of the analyzed results of the parts; synthesizing the analyzed and extracted results; and synthesizing a background image with the synthesized result.

Preferably, the source photograph may be a figure photograph, which is inputted to an input port of an automatic caricature creation machine.

The part analysis and model extraction step may include the step of analyzing the positions and sizes of respective parts of a face in the figure photograph, namely, a mouth, a nose and eyes.

The databases may be databases constructed for the respective parts of the face. More preferably, the databases may store data about eyes, noses and mouths with various characteristics.

A caricature face may be finished by extracting caricature models of the respective parts of the face from the databases. Then, a perfect caricature may be created by synthesizing the determined caricature face with other parts of the human body, such as a trunk, and a background image.

According to the present invention, a minimal amount of time is required from the source photograph input to the caricature completion. Further, with no aid of any specialist, the user can create a caricature of a desired shape as well as being able to easily access the caricature

### DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating a caricature creation method in accordance with the present invention;

FIG. 2 is a flowchart illustrating in detail an element analysis step and element model extraction step in FIG. 1, more particularly in connection with a face shape; and

FIG. 3 is a flowchart illustrating in detail the element analysis step and element model extraction step in FIG. 1, more particularly in connection with eyes, a nose and a mouth.

### DETAILED DESCRIPTION OF THE PREFERRED EMBODIMENTS

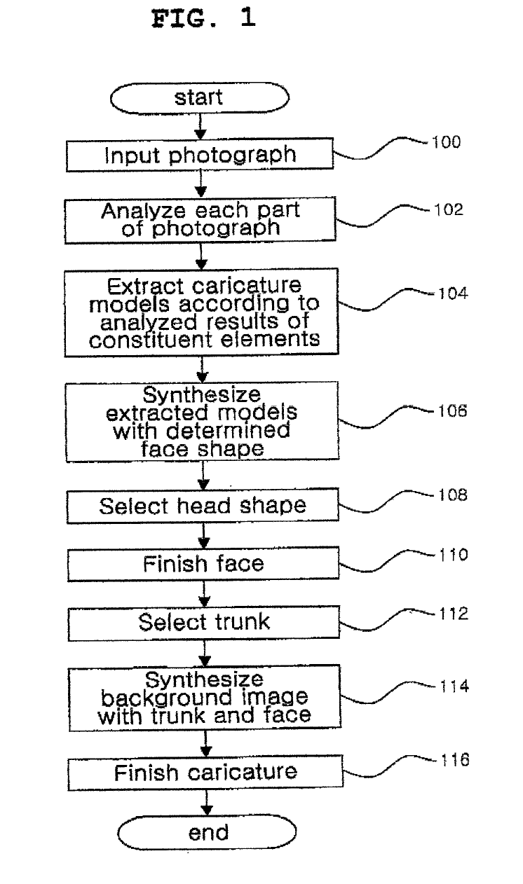

FIG. 1 is a flowchart illustrating a caricature creation method in accordance with the present invention. As shown in this drawing, the caricature creation method is performed beginning with a photograph entry step 100 at which a user enters a source photograph for caricature creation in a photograph input port of an automatic caricature creation machine. The source photograph is assumed to be the user's figure photograph in the present embodiment, although it may a star performer's figure photograph, a famous sports player's figure photograph, a famous statesman's figure photograph or other person's figure photograph. If the source photograph is entered, then each part therein is analyzed (102). Namely, analyses are made of respective elements constituting the face in the photograph, or a face shape, eyes, a nose, a mouth and the like. Thereafter, an appropriate model to be employed in a caricature is extracted on the basis of each of the analyzed results of the constituent elements (104).

A caricature can generally be considered to be the combination of various modifications of respective parts of a person. In this connection, databases must be constructed with respect to respective parts of persons in order to create a variety of caricatures. In the present embodiment, there are provided databases constructed for constituent elements of faces in source photographs. That is this embodiment provides databases constructed respectively with regard to eyes, noses and mouths. These databases have a variety of data regarding the associated elements, stored therein. For example, an eye database may store data about eyes having a variety of shapes, colors and sizes. Nose and mouth databases may be constructed in a similar manner. Other than those, the present embodiment provides a head database having a variety of data about head shapes stored therein, and databases related to other parts of the human body, for example, a trunk database.

The above-stated appropriate model of each of the constituent elements can be extracted by selecting any one adequate to the face shape from a corresponding one of the databases related to the constituent elements.

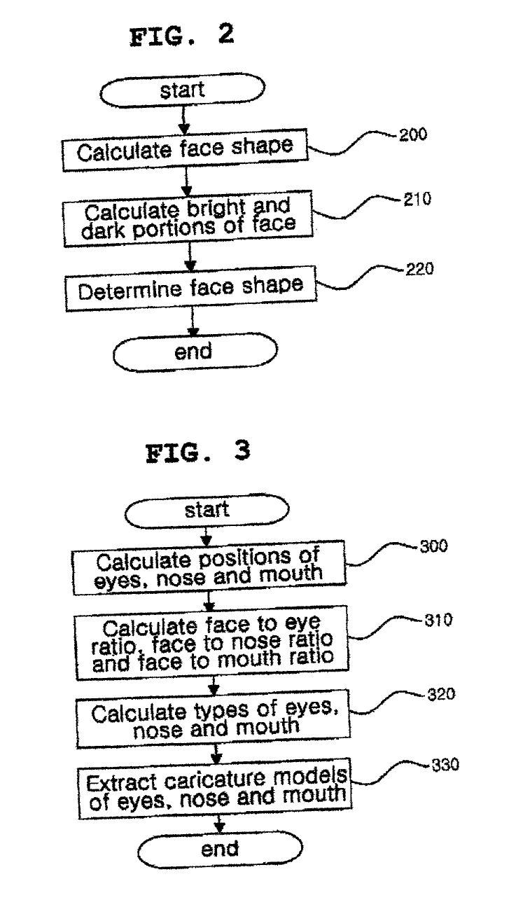

The element analysis step 102 and element model extraction step 104 will hereinafter be described in detail with reference to FIGS. 2 and 3.

FIG. 2 is a flowchart illustrating in detail the element analysis step 102 and element model extraction step 104 when a constituent element to be analyzed is the face shape. First, calculations are made as to the shape of the face in the photograph (200) and in turn as to bright and dark portions, or convex and concave portions, of the face (210). The entire face shape to be employed in the caricature is then determined on the basis of the calculated results (220).

FIG. 3 is a flowchart illustrating in detail the element analysis step 102 and element model extraction step 104 when constituent elements to be analyzed are the eyes, nose and mouth. First, calculations are made as to the positions of the eyes, nose and mouth of the face in the photograph (300). Calculations are then made as to a face to eye ratio, a face to nose ratio and a face to mouth ratio (310), thereby determining relative sizes of the eyes, nose and mouth to the area of the face in the photograph. The calculated ratios are directly applied to the face shape to be employed in the caricature, determined as stated above. After the ratios of the reactive elements are determined calculations are made as to the types of the eye, nose and mouth (320). At this step, all sizes of the elements of the face including lengths and widths of the eyes, nose and mouth, are determined centering around the positions calculated at the position calculation step 300. Subsequently, models of the eyes, nose and mouth to be employed in the caricature are extracted respectively from the eye, nose and mouth databases in consideration of the calculated ratios and sizes (330). At this time, a variety of models can be extracted by entering various variables regarding the respective elements, for example, appropriate selections of an eye color, eyebrow shape, nostril size and mouth shape depending on a desired smiling, crying or angry figure of the face.

After the analyses are made of the respective parts of the face in the photograph (102) and the appropriate models of the analyzed parts to be employed in the caricature are extracted (104), as described above, the extracted models are synthesized with the determined face shape to be employed in the caricature (106). Subsequently, a head shape adequate to the resultant face shape is selected from the head database on the basis of data about the resultant face shape (108) and the face to be employed in the caricature is then finished (110). Thereafter, for completion of the body of the caricature, a trunk appropriate to the finished caricature face is selected from the trunk database (112). The same process can also be performed with respect to the remaining parts of the body. If the trunk is selected, then the automatic caricature creation machine couples the selected trunk with the finished face according to its built-in program. One caricature can be created in this manner. As an alternative, a more perfect caricature may be made by adding a background image to the finished caricature. To this end, a background image is synthesized with the coupled result of the trunk and face (114). As a result, a perfect caricature is created (116).

Although the preferred embodiments of the present invention have been disclosed for illustrative purposes, those skilled in the art will appreciate that varies modifications, additions and substitutions are possible, without departing from the scope and spirit of the invention disclosed in the accompanying claims. For example, those skilled in the art will appreciate that the present invention is applicable in making a caricature of an animal, what is more, a character appearing on a famous animation, etc., as well as a person. Also, the above-described caricature creation method may be carried out in a different manner. For example, in the flowchart of FIG. 1, the head shape or trunk may first be selected and the respective caricature models of the face appropriate thereto may then be selected. Further, a variety of accessories, such as a hat, gloves, necklace, spectacles and the like, may be synthesized with the finished caricature to set it off. Moreover, rather than entering the source photograph, the user may be photographed through a camera mounted on the caricature creation machine and the resulting image may be used as a source for the caricature creation. Furthermore, the present invention is applicable to a variety of business fields. For example, the user may apply his or her caricature to an advertisement expressing himself or herself.

As apparent from the above description, the automatic caricature creation machine is used to perform the caricature creation method according to the built-in program as shown in FIG. 1, resulting in a small amount of time being required from the photograph input to the caricature completion. Further, with no aid of any specialist, the user can create a caricature of a desired shape as well as being able to easily access the caricature.

What is claimed is:

1. A method for creating a caricature, comprising the steps of:
a) inputting source data for the caricature creation;
b) analyzing respective parts of the inputted source data and extracting a caricature model on the basis of each of the analyzed results of the parts;
c) synthesizing the results analyzed and extracted at said step b); and
d) synthesizing a background image with the result synthesized at said step c).

2. The method as set forth in claim 1, wherein said source data is a figure photograph or an image picked up by a camera.

3. The method as set forth in claim 2, wherein said step b) includes the steps of:
b-1) calculating the shape of a face in said figure photograph or image; and
b-2) calculating bright and dark portions of said face and determining a face shape to be employed in said caricature on the basis of the calculated results.

4. The method as set forth in claim 3, wherein said step b) further includes the steps of:
b-3) calculating the positions of the eyes, nose and mouth of the face in said figure photograph or image;
b-4) calculating a face to eye ratio, a face to nose ratio and a face to mouth ratio;
b-5) calculating the types of said eyes, nose and mouth; and
b-6) extracting caricature models of said eyes, nose and mouth on the basis of the calculated results.

5. The method as set forth in claim 4, wherein said step b-6) includes the step of extracting said caricature models of said eyes, nose and mouth from an eye database, nose database and mouth database, respectively.

6. The method as set forth in claim 4, wherein said step b) further includes the step of:
b-7) synthesizing said determined face shape with the extracted caricature models of said eyes, nose and mouth, extracting a head shape and trunk appropriate to the synthesized result and coupling the extracted results with the synthesized result.
